(19) United States
(12) Patent Application Publication
(10) Pub. No.: US 2009/0259594 A1
(43) Pub. Date: Oct. 15, 2009

(54) Collaborative Funding System and Methods

(76) Inventors: Berwyn Lee Hoyt, Christchurch (NZ); Benjamin Earl Hoyt, Christchurch (NZ); Bryan Daniel Hoyt, Christchurch (NZ)

Correspondence Address: Berwyn Hoyt, PO Box 2582, Christchurch, 8140, omitted

(21) Appl. No.: 12/102,873

(22) Filed: Apr. 15, 2008

Related U.S. Application Data
(60) Provisional application No. 60/912,170, filed on Apr. 17, 2007.

(51) Int. Cl. G06Q 30/00; G06Q 20/00; G06Q 10/00; G06Q 99/00

(52) U.S. Cl. 705/80; 705/26; 705/39; 705/7; 705/30; 705/1

(57) ABSTRACT

This invention is a collaborative funding system which allows many people to work together to fund a project or to purchase a product or service. A computer system offers services to users, typically over the internet. Users may enter a new product into the system, contribute to a fund for buying a particular product or quote a product to sell it to other buyers. Once a product is quoted, the system chooses the best quote and offers the product for sale to the users. Buyers' funds are held in trust until the product is furnished. The system also provides a mechanism for the seller to build the product in stages and be paid for each stage. The system allows a negotiation between buyers and seller to determine whether the product or stage is complete.

### CROSS REFERENCE TO RELATED APPLICATIONS

Not Applicable. We have made no prior patent applications.

### STATEMENT REGARDING FEDERALLY SPONSORED RESEARCH OR DEVELOPMENT

Not Applicable.

### BACKGROUND OF THE INVENTION

The present invention relates generally to electronic commerce and, more specifically, to a system where multiple buyers collaborate to make a purchase.

The internet is becoming a popular medium in two significant areas: commerce and collaboration.

In terms of commerce, various forms of internet shopping are available ranging from electronic goods to everyday household items such as food. These may be paid for in a variety of ways—either electronically or by more traditional means. The purchased product may also be delivered to the customer in a variety of ways. In each case, the distinguishing mark of internet shopping is that the customer has used the information on the internet or has provided information via the internet to enable his purchase to proceed.

Internet collaboration is another area of rapid development where users are able to share information quickly and easily in real time. A wiki is one well-known example where many users can simultaneously submit and edit, for example, encyclopedia articles without corrupting or overwriting what another user is doing.

This kind of collaboration is assisted by a computer system that enforces certain rules on the user to prevent him from accidentally overwriting another user's work, or willfully corrupting it. In some examples of a wiki system, existing articles are protected from being overwritten by a computer algorithm that automatically merges new data with old data. If there is a merging conflict that the computer cannot resolve, then both old and new data are presented to the users, and the computer system facilitates a negotiation between the users to resolve the conflict.

Likewise, in other wiki systems, a malicious corruption or a data conflict can be mediated by an agent or third party. An internet-based computer system facilitates all the necessary communication between the users and the mediating agent.

Inventions using these technologies are well-known and documented; for example, in the following United States patents:

U.S. Pat. No. 5,895,454 Harrington

U.S. Pat. No. 5,946,665 Suzuki, et al.

U.S. Pat. No. 6,728,784 Mattaway

U.S. Pat. No. 6,959,268 Myers Jr., et al.

U.S. Pat. No. 7,035,906 Ellis, III

U.S. Pat. No. 7,069,242 Beerud D. Sheth, et al.

U.S. Pat. No. 7,176,942 Chartier, et al.

U.S. Pat. No. 7,188,081 Shah

### BRIEF SUMMARY OF THE INVENTION

The present invention is a system that joins both the concept of internet shopping and internet collaboration to enable users to share the cost of purchasing a product or service.

Another benefit of this invention is to provide a new means to fund research that will benefit a group of people. Whenever there are people who all desire the same product, they can use this invention to team up and fund research into the product or technology that mutually benefits the group.

A further advantage of the invention is to provide a centralized forum where a buyer can search by product and be linked up with other buyers of that product. This link-up will then enable them to team up for the purchase and to negotiate the terms of sale with each other and with the seller.

### BRIEF DESCRIPTION OF THE DRAWINGS

FIG. 1 is a flow chart showing the steps involved in the present invention.

FIG. 2 is a flow chart showing the steps involved in the staged purchase of a product, a part of the present invention.

FIG. 3 is a block diagram showing a network system that implements the present invention.

### DETAILED DESCRIPTION OF THE PREFERRED EMBODIMENTS

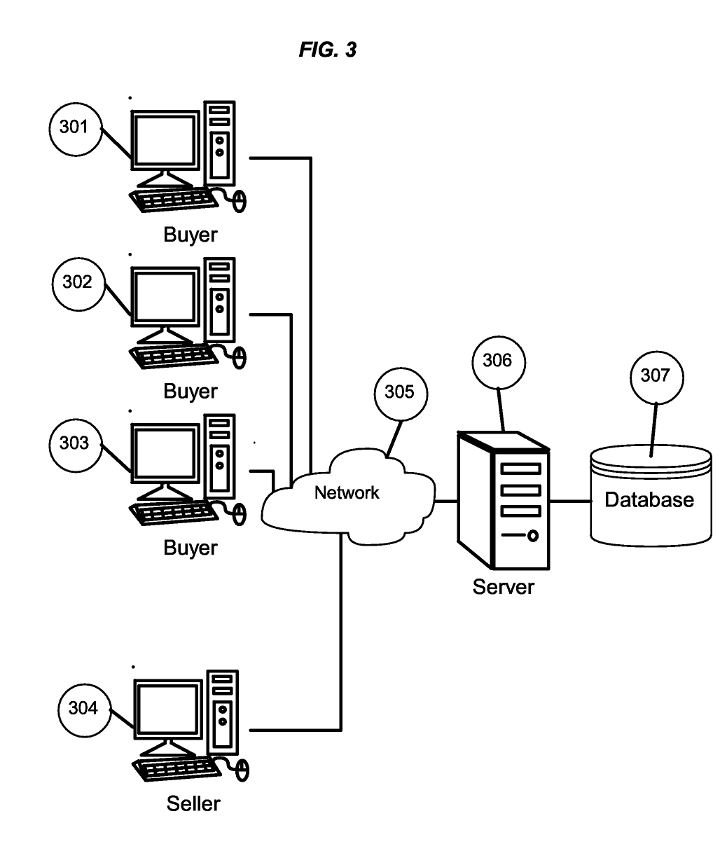

The described embodiment discloses a system and method that facilitates collaborative funding. The elements of this system are illustrated in FIG. 3 showing a plurality of buyer computers 301, 302, 303 and one or more seller computers 304, all connected together with one or more server computers 306 by means of a computer network 305. The server runs a database.

It should be noted that the system will operate with just one buyer 301, but that is not covered by this invention as it has already been implemented all over the world in the form of, for example, internet shopping (U.S. Pat. No. 5,895,454) and software marketplaces (U.S. Pat. No. 7,069,242). It should also be observed that although only one server, one seller, and one database has been shown, the present invention also includes more than one of each.

The preferred computer network 305 is the internet which is preferred because it permits the connection of the largest number of users to the system. This is because a larger user base presents probability that there will be collaborators of similar intent. A pecularity of this invention is that where there are more collaborators, the cost to each individual may be reduced in proportion. Alternatively, a larger number of collaborators can make it possible to meet the cost of a product that would otherwise not have been available to each individual buyer. A related advantage is to the seller who can sell a product for which he would otherwise not have had buyers.

A further advantage of using the computer system with a database as previously described with reference to FIG. 3, is that it lets any user enter a product specification onto the database by means of the network and server. This will increase the range of products that other potential buyers can search for.

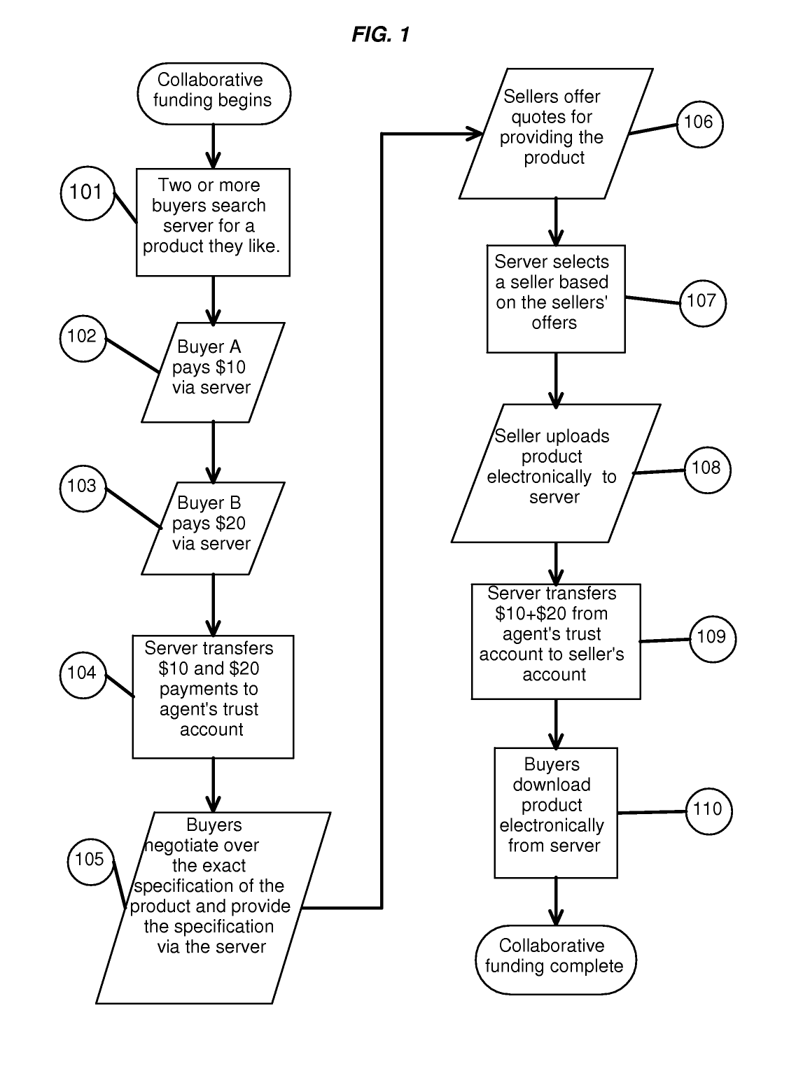

The system operates according to the method illustrated in FIG. 1. A typical funding operation will begin with two or more buyers 101 performing a searching operation for a service or product they wish to help fund. A buyer may pay any amount he chooses for the product. In 102 and 103 the dollar figures are just examples, and are referenced throughout the diagram. Although only two buyers are shown, it is possible to have an unlimited number of buyers all contributing to the one product. The more buyers there are, the lighter the burden of cost on each buyer.

The amounts paid by the buyers are held in the trust account of an agent 104. The agent account would typically be an account that is associated with the company running the server system.

Buyers can negotiate 105 over the exact specification of the product. Typically, but not necessarily, this would be by means of an online discussion forum presented by the server. A typical example of usage is where the product is a software product. The buyers specify or request particular features to be included in the product. However, products sold with this system are not limited to computer products and may include any product where collaboration is desirable, for example the building of public works.

Based on the product specification, various sellers may now quote 106 and the server will select a seller to provide the product 107. The selection of a seller takes place by an online vote or negotiation or by an automatic selection based on the value of the quote or any other aspects of the quote.

Once the seller is chosen he develops or provides the product 108 as required in the specification. If the product is an electronic product, it may be provided by upload to the server, but electronic provision is not mandatory, and for some products will be impossible.

Once the product is provided, the server transfers the total money from the trust account to the seller 109, and if the product is electronic, the server permits the buyers to access the product 110.

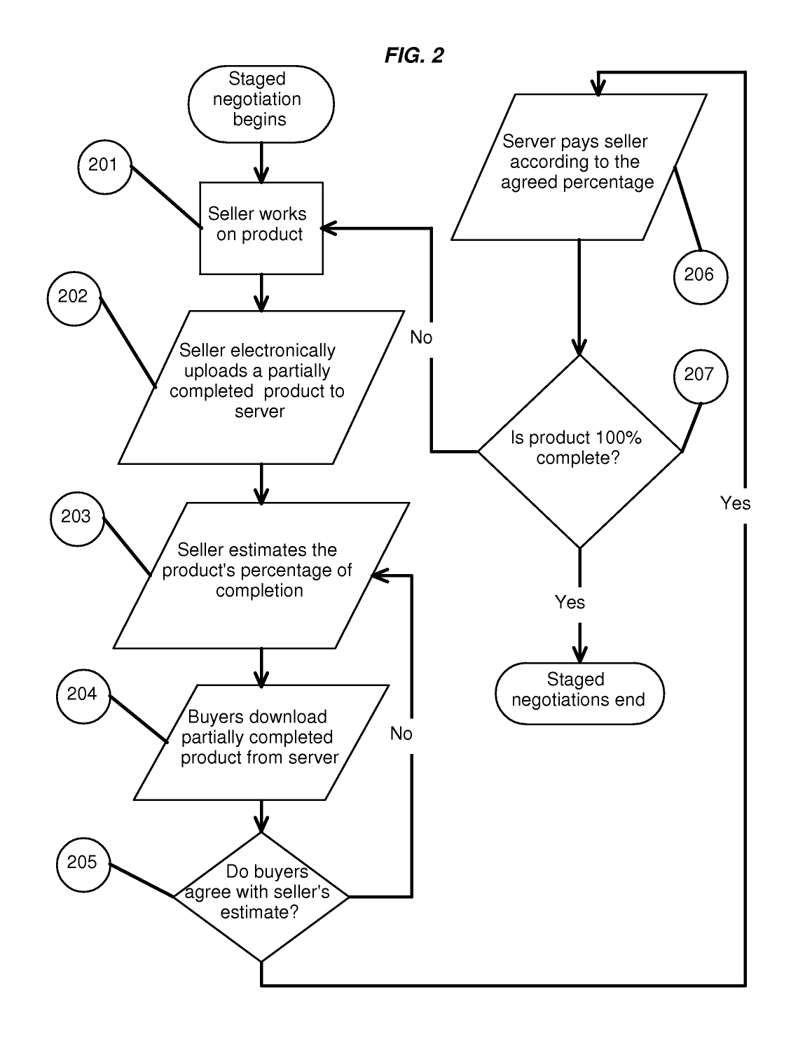

A further expansion on steps 108 through 110 of FIG. 1 are shown in FIG. 2. Not only does FIG. 2 illustrate a negotiation between buyer and seller to decide what constitutes a finished product, but it allows the product to be provided and paid for in stages. This process begins with the seller partially completing the product, as in feature 201 of FIG. 2, and making it available for evaluation by the buyers. In the case of an electronic product, it may be uploaded to the server 202. The seller estimates how much of the product he has provided 203 and the buyers examine 204 and evaluate the product 205.

If the buyers do not agree that the product is as complete as the seller thinks then a negotiation takes place and the process proceeds again from step 203. Once the buyers agree with the seller, the the server pays the seller from the trust account according to the percentage of work that the seller has done 206. For example, at the point when the buyers and seller agree that the product is 30% complete, the seller is paid 30% of the total purchase price. This whole process in FIG. 2 can be repeated indefinitely until the buyers and seller agree that the product is 100% complete 207, at which point the final payment is made, completing the collaborative funding process.

It should be noted again that while an electronic product has been assumed in FIG. 2 for the sake of clarity, the invention is also designed to handle other kinds of products.

An advantage of the staged negotiation just described is that the seller does not have to wait until there are buyers for the full quoted price of the product. The system allows the seller to begin work on the product, and even to be paid for stages of its development while, at the same time, buyers are adding to the fund.

A further scenario included in the invention is where a plurality of sellers collaborate as a group to provide the product to the buyers as though this group of sellers were the single seller referred to up to this point. In this scenario, the all the sellers provide input to the product and simply agree between themselves on the distribution of the proceeds of sale. The server may also automatically determine the distribution of the proceeds between the sellers based on each seller's level of input into the product, or on any other relevant criteria.

If a conflict arises between any of the parties at any stage, a conflict resolution service is offered by the system which includes a discussion forum and the option of a third-party mediator to assist the aggrieved parties.

In view of the above description, it is apparent that the invention provides a collaborative funding method and system. The above description relates only to the exemplary embodiments of the present invention, and numerous changes may be made to it without departing from the scope and spirit of the invention defined by the claims below. The claims below define the exclusive rights of the invention.

That which is claimed is:

1. A method for a plurality of buyers to collaborate in providing funds to a seller, the method comprising the steps of: a plurality of buyers collaborating by submitting funds for the payment of a product or service to a seller, wherein both the collaboration and submitting of funds is done by means of a central computer system via a computer network; the seller providing the product or service to the buyers.

2. The method of claim 1, further comprising an intermediate step wherein funds from the buyers are paid to an agent who then pays the seller.

3. The method of claim 2, wherein the agent holds the funds in trust while the product or service is being made ready for sale or while any other condition of sale is being met.

4. The method of claim 1, wherein the seller provides the product or service to the buyers electronically by means of a central computer system via a computer network.

5. The method of claim 1, further comprising a preliminary step wherein the product, service or payment terms are specified or negotiated by any of the parties or a third party by means of a central computer system via a computer network.

6. The method of claim 1, further comprising a step wherein one of a plurality of sellers is chosen to provide the product or service by means of a negotiation or voting process by the buyers by means of a central computer system via a computer network.

7. The method of claim 1, further comprising a step wherein one of a plurality of sellers is chosen to provide the product or service based on each seller's terms of sale, selecting the seller who can provide the lowest cost, quickest delivery, highest quality, or a weighted combination of these or other terms of sale.

8. The method of claim 1, wherein the product or service is paid for in stages as the product is developed, or as the service is provided.

9. The method of claim 8, wherein the said payment stages are determined by negotiation or voting by means of a central computer system via a computer network.

10. The method of claim 1, further comprising a preliminary step for assisting buyers to find like-minded buyers with whom to collaborate, wherein a central computer system keeps a database of which buyers are interested in which products or services, and presents that information to the buyers when they request a search by product.

11. The method of claim 1, further comprising a step to resolve any conflict between the buyers and seller; wherein a central computer system facilitates the resolution by means of a discussion forum or by allowing a third party to mediate between the aggrieved parties.

12. The method of claim 1, further comprising a step wherein a plurality of sellers collaborate to provide the product; wherein the sellers negotiate and agree in advance to determine the distribution of funds between the sellers; the funds being the proceeds of the sale.

13. A system assisting a plurality of buyers to collaborate in providing funds to a seller, the system comprising: at least one computer used by at least one buyer; at least one server computer; a computer network connecting the buyers' computers with the server computer; at least one database operably connected to the server; wherein the server computer receives funds electronically over the network from a plurality of users who are buyers to let them collaborate by submitting funds electronically via the network for the payment of a product or service; wherein the database stores records and accounts of buyers, sellers and products that are necessary to facilitate a sale between buyers and seller; wherein the server facilitates payment of the funds to the seller.

14. The system of claim 13, wherein the server lets the buyers pay the funds to an agent who then pays the seller.

15. The system of claim 14, wherein the server lets the agent hold the funds in trust while the product or service is being made ready for sale or while any other condition of sale is being met.

16. The system of claim 13, wherein the server lets the seller provide the product or service to the buyers electronically.

17. The system of claim 13, wherein the server lets the product, service or payment terms be specified or negotiated by any of the parties or a third party.

18. The system of claim 13, wherein the server lets the users choose one of a plurality of sellers to provide the product or service by means of a negotiation or voting process by the buyers.

19. The system of claim 13, wherein the server runs a computer program which selects one of a plurality of sellers to provide the product or service where the algorithm run by the program is based on each seller's terms of sale, selecting the seller who can provide the lowest cost, quickest delivery, highest quality, or a weighted combination of these or other terms of sale.

20. The system of claim 13, wherein the server lets the buyers pay for the product or service in stages as the product is developed, or as the service is provided.

21. The system of claim 20, wherein the server facilitates negotiation or voting on the terms of the said payment stages.

22. The system of claim 13, wherein the server lets buyers find like-minded buyers with whom to collaborate; wherein information is provided to the buyers from a database when the buyers request a search by product.

23. The system of claim 13, wherein the server facilitates the resolution of any conflict between the buyers and seller by means of a discussion forum or by allowing a third party to mediate between the aggrieved parties.

24. The system of claim 13, wherein the server lets a plurality of sellers collaborate to provide the product; wherein the server provides a service that lets the sellers negotiate and agree between themselves to determine the distribution of funds between the sellers; the funds being the proceeds of the sale.

25. The system of claim 24, wherein the negotiation over distribution of funds is replaced by an allocation of funds that is made automatically by a computer program running on the server where the algorithm run by the program is based on each seller's level of input into the product or on any other criteria related to the sellers.
